(19) United States
(12) Patent Application Publication
(10) Pub. No.: US 2008/0112107 A1
(43) Pub. Date: May 15, 2008

(54) Method for controlling an electrical discharge using electrically conductive fluid materials

(76) Inventor: Walter W. Stumberger, Hightstown, NJ (US)

Correspondence Address: Walter W. Stumberger, 203 Dutch Neck Road, Hightstown, NJ, 08520, US

(21) Appl. No.: 12/004,983

(22) Filed: Dec. 26, 2007

Related U.S. Application Data
(63) Continuation of application No. 10/756,517, filed on Jan. 14, 2004.

(51) Int. Cl. H01T 1/20; H02J 7/00

(52) U.S. Cl. 361/253; 320/166

(57) ABSTRACT

The method of this invention uses selected conductive fluid substances such as common saltwater, suspensions, colloids, and gases to electrically connect electrically charged electrodes and pass electricity through the selected substance thereby discharging some or all of the electrical charge accumulated in a power system without the need for complex and un-reliable electrical triggering mechanisms.

This application claims priority based on U.S. Provisional patent application Ser. No. 10/756,517, filed Jan. 14, 2004, entitled “A Method For Controlling An Electrical Discharge using electrolytes and other electrically conductive fluid materials”, which is incorporated here by reference in its entirety.

### STATEMENT REGARDING FEDERALLY SPONSORED RESEARCH AND DEVELOPMENT

No Government funds were used to develop this invention defined and controlled electrical paths between the said electrically charged electrodes and transferring electrons between the said electrically charged electrodes.

### BACKGROUND OF THE INVENTION

The value of quickly converting conductive substances, such as water (HOH) doped with a chemical like ordinary table salt (NaCi) into high pressure steam and explosive gases through the use of a quickly applied electrical discharge is known and used in a variety of processes such as blasting rocks, drilling boreholes, and propelling projectiles.

Prior art, however, requires that the electrodes that apply the electric current be immersed in the selected substance first, with some further devices and processes requiring a trigger wire to short-circuit the electrodes and start the discharge and conversion process.

In most cases a high voltage, high current, triggering mechanism is required to control the timing and duration of the electrical discharge through the selected substance. Further the triggering mechanisms are sometimes unreliable and had shorter than desired functional lifetimes.

In this art the selected substance itself acts as the discharge causing and controlling mechanism.

This disclosure relates to electrochemistry in various forms as well as electrical discharge systems.

A wide range of convenient substances can be used successfully in the process described here.

### SOME PRIOR ART

Some Prior Art relating to the process of using the sudden application of electrical current to convert elected substances to different and useful substances with different and useful characteristics are:

| Patent Number | Date | Inventor | Area |
|---|---|---|---|
| 2953353 | September, 1960 | Allen | 175/1 |
| 3143069 | April, 1964 | Ostrow et al | 102/28 |
| 3158207 | January, 1964 | Bailey | 299/14 |
| 3225252 | February, 1965 | Schrom et al | 315/111 |
| 3267720 | August, 1966 | Escallier | 73/12 |
| 3283294 | January, 1966 | Schrom | 166/63 |
| 3364708 | January, 1968 | Padberg, Jr. | 72/56 |
| 3500942 | March, 1970 | Smith, Jr. | 175/16 |
| 3583766 | June, 1971 | Padberg, Jr. | 299/14 |
| 3679007 | July, 1972 | O'Hare | 175/16 |
| 3708022 | January, 1973 | Woodruff | 175/2 |
| 3840078 | October, 1974 | Allgood et al. | 175/15 |
| 4334474 | June, 1982 | Coltharp | 102/206 |
| 4343356 | August, 1982 | Riggs et al. | 166/249 |
| 4479680 | October, 1984 | Wesley et al. | 166/299 |
| 4658699 | April, 1987 | Dahn | 89/8 |
| 4741405 | May, 1988 | Moeny et al. | 175/16 |
| 4895062 | January, 1990 | Chryssomallis et al | 89/7 |
| 4897577 | January, 1990 | Kitzinger | 315/55 |
| 4974487 | December, 1990 | Goldstein et al. | 89/7 |
| 5052272 | October, 1991 | Lee | 89/7 |
| 5072647 | December, 1991 | Goldstein et al. | 89/8 |
| 5083615 | January, 1992 | McLaughlin et al. | 166/299 |
| 5106164. | May, 1992 | Kitzinger et al | 299/14 |
| 5287791 | February, 1994 | Chaboki et al | 89/8 |
| 5425570 | June, 1995 | Wilkinson | 299/14 |
| 5482357 | January, 1996 | Wint et al | 299/14 |
| 5773750 | June, 1998 | Jae et al | 102/302 |

### BRIEF SUMMARY OF THE INVENTION

The method of this invention puts a selected substance of less electrical resistance across a gap of higher electrical resistance separating electrically charged electrodes causing electricity to pass through the selected substance and discharge some or all of the initial electrical charge on the electrodes and change the physical properties of the selected substance so as to open the circuit again. A higher level of dependability and flexibility is provided in discharging the electrical source and converting the selected substance.

### BRIEF DESCRIPTION OF THE SEVERAL VIEWS OF THE DRAWINGS

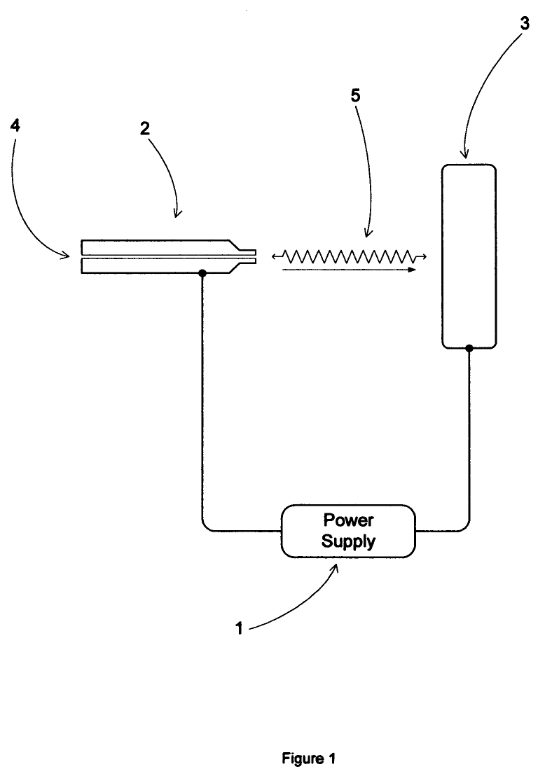

Please refer to FIG. 1.

The Power Supply (1) provides an electrical charge to the electrodes (2 and 3). A selected substance is delivered through a convenient delivery system at (4) under sufficient pressure that the selected substance is ejected from the electrode (2) and forms an electrical bridge (5) between the proximal electrode (2) and the distal electrode (3).

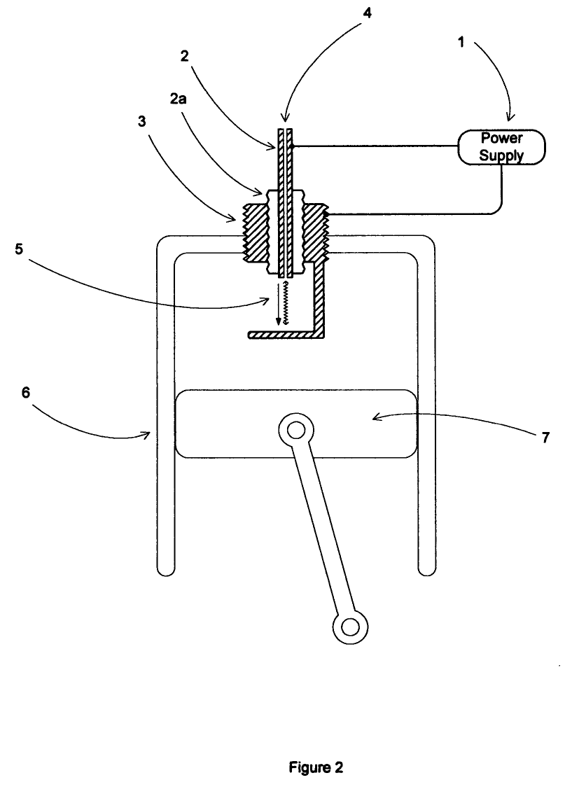

Please refer to FIG. 2, which is an embodiment.

In this embodiment the rigid container (6) supports the triggering mechanism as well as a movable piston (7). Power Supply (1) provides an electrical charge to the electrodes (2 and 3). A selected substance is delivered through a convenient delivery system at (4) under sufficient pressure that the selected substance is ejected from the electrode (2) and forms an electrical bridge (5) between the proximal electrode (2) and the distal electrode (3) causing a flow of electricity. Insulator (2a) electrically separates the electrodes.

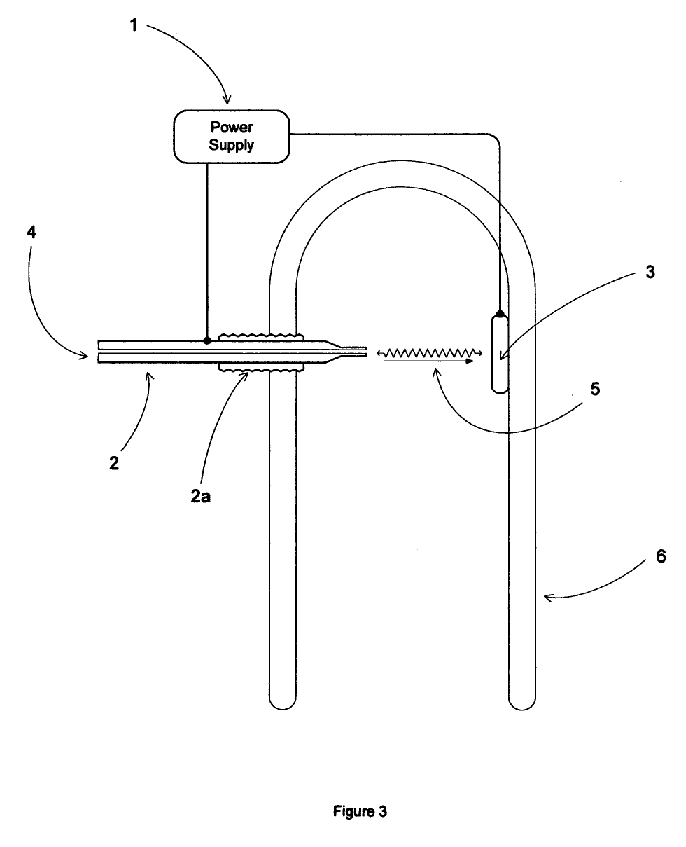

Please refer to FIG. 3, which is an embodiment.

Power Supply (1) provides an electrical charge to the electrodes (2 and 3). A selected substance is delivered through a convenient delivery system at (4) under sufficient pressure that the selected substance is ejected from the electrode (2) and forms an electrical bridge (5) between the proximal electrode (2) and the distal electrode (3) causing a flow of electricity. Insulator (2a) electrically separates the electrodes and rigid container (6) provides a means for directing any exhaust gases.

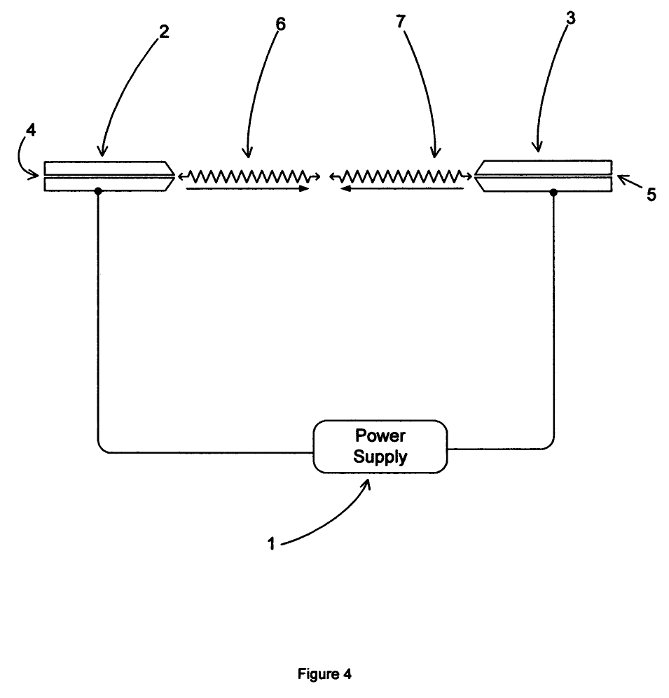

Please refer to FIG. 4, which is an embodiment.

The Power Supply (1) provides an electrical charge to the electrodes (2 and 3). Selected substances are delivered through convenient delivery systems at (4 and 5) under sufficient pressure that the selected substances are ejected from the electrodes (2 and 3) and form electrical bridges (5 and 7) between the two electrodes (2 and 3).

### DETAILED DESCRIPTION OF THE INVENTION

In this method for controlling an electrical discharge a convenient power supply or power source provides a convenient net electric charge by way of convenient circuits and connection systems to electrically opposing electrodes of convenient number, shape, size, position, attitude, and composition where no electrode participating in the discharging process has any electrical circuit based electrical connectivity with any electrically opposing electrode except through the power supply or power source. One or a plurality of the electrodes have in some convenient proximity to themselves a delivery system for delivering a selected conductive fluid substance in such a way that the selected substance will have a general shape where the inter-electrode longitudinal axial length equals or exceeds any cross section dimension and a close electrically conductive relation with each said proximal electrode and be able to accept the electrical condition of each proximal electrode and under some convenient force enter the space between the said electrodes and extend the proximal electrode's electrical condition some convenient distance sufficiently close to the selected target electrode so as to provide an electrical path of less electrical resistance than the un-bridged gap between the selected electrodes and transfer some or all of the electrical charge between and among the said electrodes. It is obvious from the above description that any electrically opposing electrodes of whatever configuration or number can each participate in having its electrical charge extended into a properly prepared gap between the electrically opposing electrodes using a conveniently selected conductive fluid in the process described above and that the actions may be symmetrical or asymmetrical. It is also obvious from the above description that any bolus of conductive fluid could be a single continuous bolus or one made up of multiple sub-boli. Conditions and substances suitable for preparing the gap or space between opposing electrodes include but are not limited to full or partial vacuum, ambient atmosphere, poorly conductive gases of any convenient pressure, and poorly conductive fluid substances, provided any selected gap preparing substance or condition is of a higher electrical resistance than the selected fluid bridging substance and the selected gap substance or condition would allow the bridging substance to reach the charge of an electrically opposing electrode.

Because there are no complex or unreliable triggering mechanisms involved a higher level of dependability is achieved.

From the foregoing it will be appreciated by those skilled in the art that the presented method provides an effective and advantageous method for overcoming many of the limitations associated with discharging electrical systems.

It will also be readily appreciated by one with ordinary skill in the art to use the method of the present disclosure in other configurations.

Although certain presently preferred embodiments of the present disclosure have been described herein it will be apparent to those skilled in the art to which this disclosure pertains that modifications of the various embodiments shown herein may be made without departing from the spirit and scope and protection of this disclosure.

The attached descriptions and drawings and claims are regarded by the applicant as including a variety of individually inventive concepts, some of which may lie partially or wholly outside the scope of some or all of the claims. The fact that the applicant has chosen to restrict the claimed scope of protection in accordance with the attached claims is not to be taken as a disclaimer for alternative concepts that are included in the contents of the application and could be defined by claims differing in scope from the attached claims which different claims may be adopted at some later time.

1. The invention claimed is a method for discharging a charged electrical system through the controlled introduction of a selected fluid substance or plurality of selected fluid substances of appropriate dimensions and constituting a lesser electrical resistance across a suitably prepared gap of higher electrical resistance between electrically charged and electrically segregated electrodes and with said selected fluid substance or plurality of selected fluid substances each physically extending and providing a defined and controlled electrical path or plurality of defined and controlled electrical paths between the said electrically charged electrodes and transferring electrons between the said electrically charged electrodes.

2. The invention claimed is a method for discharging a charged electrical system through the controlled introduction of a selected fluid substance or a plurality of selected fluid substances of appropriate dimensions and constituting a lesser electrical resistance into a suitably prepared gap of higher electrical resistance between electrically charged and electrically segregated electrodes and with said selected fluid substance or plurality of selected fluid substances each physically extending and providing a defined and controlled electrical path or a plurality of
